(19) United States
(12) Patent Application Publication
(10) Pub. No.: US 2008/0276747 A1
(43) Pub. Date: Nov. 13, 2008

(54) Actuator for a Clamping Mechanism of an Adjustable Steering Column

(75) Inventors: Maik-Oliver Schuette, Delingsdorf (DE); Peter Von Ey, Hamburg (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 12/064,789

(22) PCT Filed: Aug. 1, 2006
(86) PCT No.: PCT/EP2006/007590

§ 371 Date: Jul. 8, 2008

(30) Foreign Application Priority Data
Aug. 26, 2005 (DE) 10 2005 040 477.4

(51) Int. Cl. B62D 1/18

(52) U.S. Cl. 74/493

(57) ABSTRACT

The invention relates to an actuator for a clamping mechanism of an adjustable steering column of a motor vehicle, by way of which actuator a clamping apparatus can be moved between a release position for adjusting the steering column and a clamping position for fixing the steering column in position, the actuator comprising a gear mechanism having a plurality of gear elements which are in engagement with one another. In order to provide an actuator which can be transferred considerably more quickly into its release position, an actuating device (26) is provided according to the invention, by means of which at least two of the gear elements (18, 20) of the actuator can be moved out of mutual engagement.

### BACKGROUND AND SUMMARY OF THE INVENTION

This application is a national stage of PCT International Application No. PCT/EP2006/007590, filed Aug. 1, 2006, which claims priority under 35 U.S.C. §119 to German Patent Application No. 10 2005 040 477.4, filed Aug. 26, 2005, the entire disclosure of which is herein expressly incorporated by reference.

The invention relates to an actuator for a clamping mechanism in an adjustable steering column of a motor vehicle

In a known actuator of this type, disclosed in German patent document DE 198 27 464 A1, a clamping apparatus can be moved between a release position for adjusting the steering column in the axial or vehicle vertical direction, and a clamping position for fixing the steering column in position. The actuator for moving the clamping apparatus comprises substantially a rack which interacts with a drive pinion and can be moved translationally in one direction to clamp the steering column fixedly and in the opposite direction to release the steering column. For this purpose, the drive pinion is moved in either the clockwise or counterclockwise direction. The actuator which is described there therefore requires the same time period for clamping and releasing the steering column.

German patent document DE 101 52 807 A1 discloses an actuator, in which a spindle can be retracted and extended translationally. A clamping disk is pivoted via this spindle about an axis relative to a second clamping disk between a release position and a clamping position, with the axial spacing between the two clamping disks being at its smallest in the release position and at its greatest in the clamping position. The steering column is clamped fixedly with respect to a steering bracket as a result of this change in the axial spacing between the two clamping disks. The same time is also required for clamping and releasing the steering column in this actuator.

One object of the present invention to provide an improved actuator of the type mentioned above, in such a way that the time period for releasing the clamping position can be reduced considerably.

This and other objects and advantages are achieved by the actuator according to the invention, which includes an actuating device by which at least two of the gear elements of the actuator can be moved out of mutual engagement. As a result, it is possible to cancel the clamping position of the clamping apparatus very quickly, so that the steering column can be adjusted in the axial direction or in the vertical direction immediately after being released (which is virtually undetectable for the driver of the motor vehicle). The actuator according to the invention can therefore resolve simply the conflicting goals that first the clamping position of the clamping apparatus be of very rigid configuration, with the steering column fixed satisfactorily, while the clamping position must also be releasable in a short time. A very high transmission ratio of the actuator can then be selected (by the suitable selection of the gear elements), so that a very rigid and self-locking clamping action of the steering column can be realized. The disadvantage which has previously been associated with this, namely that a long release time for reaching the release position of the clamping apparatus is also caused by a high transmission ratio, is avoided according to the invention in a technically simple manner by the disengagement of the at least two gear elements of the actuator. The conflict of objectives between a rigid and self-locking clamping action of the steering column and a quick release of the clamping position is therefore resolved in an advantageous way.

A worm shaft and a gearwheel which interacts with it have proven to be particularly advantageous gear elements which can be moved out of mutual engagement and into engagement with one another in a technically reliable way. Here, the toothing system between the worm shaft and the gearwheel can be designed in a simple way such that correct engagement is set automatically. If the pitch of the worm shaft is designed so that it interacts with the gearwheel which engages into it with a self-locking action when the actuator is at a standstill, a braking or locking device within the actuator can be dispensed with or it can at least be of very much smaller design.

It has also proven advantageous to provide a free wheel between the actuator and the actuating device, so that the actuating device remains deactivated in a movement direction for clamping the steering column and can be activated in the opposite movement direction of the actuator.

If the actuating device comprises a spindle nut which can be moved along a spindle, the pitch of the spindle can be designed in a simple manner so that the two gear elements which are in engagement can be moved out of mutual engagement very quickly.

In particular, by a suitable selection of the pitch of the spindle, the spindle nut can be restored by means of a spring element in a simple manner, such that the two gear elements come into mutual engagement again. For this purpose, the pitch of the spindle is to be selected correspondingly so that no self-locking action occurs between the spindle and the spindle nut.

Advantageously, after the at least two gear elements have been moved out of mutual engagement, a further gear element can be moved from a position which is assigned to the clamping position of the clamping apparatus into a position which is assigned to the release position of the clamping apparatus. As a result, it is possible to restore the clamping apparatus from the clamping position into the release position very quickly. For this purpose, a spring device whose spring force restores the further gear element can be restored, has proven particularly simple in structural terms.

Finally, particularly quick restoration of the clamping device from the clamping position into the release position can be achieved if the spindle of the actuating device has a considerably greater pitch than the worm shaft of the actuator.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic illustration of an embodiment of the actuator according to the invention for a clamping apparatus of an adjustable steering column of a motor vehicle; and

FIG. 2 is a further schematic illustration of the actuator according to FIG. 1, with an actuating device of alternative configuration.

### DETAILED DESCRIPTION OF THE DRAWINGS

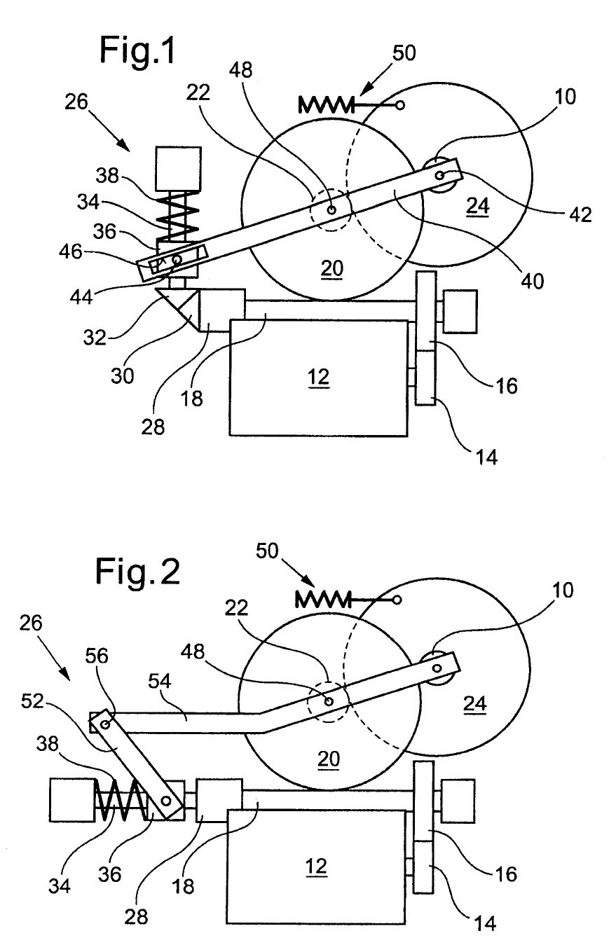

FIG. 1 shows an electrically operated actuator, with which a clamping mechanism of an adjustable steering column of a motor vehicle can be operated, such as can be gathered, for example, from German patent document DE 101 52 807 A1, to which reference is made expressly herewith with respect to the clamping mechanism itself. (Because the latter is well known, it is not discussed further herein.) A clamping mechanism of this type which can also be driven by the present actuator comprises a clamping apparatus, by which a steering column that can be adjusted axially and in the vehicle vertical direction, can be fixed with respect to a bracket. To this end, the clamping apparatus comprises two clamping disks which can be pivoted about a pivoting axis by means of the actuator, in such a way that the axial spacing between the two clamping disks changes. The axial spacing of the two clamping disks with respect to one another is at a minimum in the release position, and reaches its maximum in the clamping position. The present actuator comprises a drive axle 10, explained in further detail in the following text, via which the two clamping disks can be moved or pivoted relative to one another between the release position and the clamping position.

An electric motor 12 comprises, on the output side, a motor pinion 14 which engages with a first gearwheel 16. For its part, the first gearwheel 16 is connected radially fixedly to a worm shaft 18 and drives the latter correspondingly. A second gearwheel 20 which is fixedly connected to a second pinion 22 engages with the worm shaft 18. The second pinion 22 is in engagement with a third gearwheel 24 which for its part is fixedly connected (in terms of rotation) to the drive axle 10 for the above-described clamping apparatus. The gear mechanism which is therefore arranged between the electric motor 12 and the drive axle 10 has a relatively high transmission ratio, so that a relatively high revolution speed of the electric motor 12 is translated into a very low revolution speed of the drive axle 10.

The worm shaft 18 has a relatively low pitch, such that it interacts with the second gearwheel 20 which engages into it with a self-locking action when the electric motor 12 or the entire actuator is at a standstill. In other words, in particular, the toothing system between the worm shaft 18 and the second gearwheel 20 is designed so that no reverse movement (in particular, of the drive axle 10) takes place on account of settling operations within the gear mechanism when the actuator is at a standstill (as is the case, for example, in the clamping position of the clamping apparatus). As a result, the clamping position of the steering column is maintained reliably and continuously. In addition, the self-locking action of the worm shaft 18 causes the electric motor 12 not to be loaded with a counteracting moment.

To release the clamping position of the clamping apparatus, the actuator comprises an actuating device 26 which is arranged on the left next to the second gearwheel 20 in FIG. 1, and is connected to the worm shaft 18 via a free wheel 28. The latter is designed in such a way that the actuating device 26 is not activated in the forward rotational direction of the electric motor 12 (that is, in that rotational direction in which the clamping apparatus is transferred into its clamping position), or is not loaded with a torque of the worm shaft 18 during idling. If, in contrast, the electric motor 12 is operated in the opposite reverse rotational direction, the free wheel 28 engages with, and transmits the torque of the worm shaft 18 to, the actuating device 26.

To the latter end, the actuating device 26 comprises two straight bevel gears 30, 32 which interact with one another and via which the torque of the worm shaft 18 can be transmitted to a spindle 34. A spindle nut 36, which can be moved along the spindle 34, is moved upward in FIG. 1, counter to the spring force of a spring element 38, during reverse operation of the electric motor 12 and corresponding activation of the actuating device 26. The spindle nut 36 is connected via a pivotable-slidable guide to a lever arm 40 which for its part, at its end which faces away from the actuating device 26, is mounted via a bearing axle 42, for example, on a housing (not shown) of the actuator in the region of the drive axle 10. In order to realize the pivotable-slidable guide of the lever arm 40, the spindle nut 36 comprises a radially projecting guide bolt 44 which engages into a guide 46 of the lever arm 40, which guide 46 is recessed in a slot-like manner. In a central region of the lever arm 40, the second gearwheel 20 and the second pinion 22 which is connected fixedly to the former are mounted in the region of a common rotational axis 48.

If the electric motor 12 is moved counter to the forward rotational direction (the clamping direction), in a reverse rotational direction (a release direction) of the clamping apparatus, the free wheel comes into engagement and the spindle 34 is rotated via the two straight bevel gears 30, 32. Counter to the spring force of the spring element 38, the spindle nut 36 is moved in the upward direction and drives the lever arm 40 which is held at the other end in the region of the bearing axle 42 upward via the guide bolt 44 or the guide 46. As a result, the worm shaft 18 and the second gearwheel 20 move out of mutual engagement, so that, in particular, the drive axle 10 of the clamping apparatus which is situated in the clamping position is not loaded further with a torque which secures the clamping position. Rather, the secured clamping position of the clamping apparatus which is generated by the self-locking action between the worm shaft 18 and the second gearwheel 20 is canceled and the drive axle 10 can be pivoted back in the counterclockwise direction counter to its clamping direction. This takes place with the aid of a restoring device 50 (a spring in the embodiment). The spring of the restoring device 50 is prestressed during the clamping operation by a movement of the drive axle 10 or the third gearwheel 24 in the clockwise direction and remains in this prestressed position over the entire time period, in which the clamping apparatus and the drive axle 10 assume the clamping position. If, in contrast, the second gearwheel 20 is moved out of mutual engagement with the worm shaft 18, so that no torque which holds the clamping position further is also transmitted to the third gearwheel 24, it is turned back counter to the clockwise direction via the spring force of the spring device of the restoring device 50. As a result, the drive axle 10 is likewise turned back counter to the clockwise direction and the clamping apparatus is transferred from its clamping position into its release position.

The pitch of the spindle 34 of the actuating device 26 is selected to be relatively large, so that the second gearwheel 20 already moves out of engagement with the worm shaft 18 at low revolutions of the spindle nut 36. As a result, during reverse operation of the electric motor 12, in order to cancel the clamping position of the clamping apparatus and to transfer it into its release position, restoring of the drive axle 10 counter to the clockwise direction is achieved in an extremely quick way. In other words, the spindle 34 has a considerably greater pitch than the worm shaft 18, which ensures that a very rigid and self-locking clamping action of the clamping apparatus is achieved during forward operation of the electric motor 12, whereas the release position of the clamping apparatus can be reached extremely quickly during reverse operation of the electric motor 12.

After the releasing operation has ended and the drive axle 10 or the clamping apparatus is transferred into its release position, the electric motor 12 is switched off. As a result, the free wheel 28 moves out of engagement with the worm shaft 18 again, so that the spindle 34 and the spindle nut 36 are not loaded further with a torque of the worm shaft 18, but rather are freely movable. The spindle nut 36 is therefore moved back via the spring force of the spring element 38 along the spindle 34 again into its initial position (the lower position, shown in FIG. 1), as a result of which the lever 40 is also moved downward with its end which faces away from the bearing axle 42 via the guide 46 which interacts with the guide bolt 44. As a result, the second gearwheel 20 comes into engagement with the worm shaft 18 again, and the actuator again reaches its initial position.

In order to transfer the clamping apparatus into its clamping position again, the electric motor 12 can then be switched to forward operation, so that the drive axle 10 is driven in the clockwise direction, and the clamping disks of the clamping apparatus are moved against one another as a result. At the same time, the restoring device 50 is stressed again during a movement of this type of the drive axle 10. It can be seen that complicated actuation of the clamping mechanism can be dispensed with as a result of the mechanics of the actuator, since the behavior of the system is dependent only on the polarity of the electric motor 12. Within the context of the invention, it goes without saying, that another type of drive can be selected instead of an electric motor 12.

FIG. 2 diagrammatically shows an alternative refinement of the actuator, which is distinguished from the design according to FIG. 1, in particular, by a different type of actuating device 26. Here, the spindle 34 is arranged in the direction of extent or axial direction of the worm shaft 18, so that the two straight bevel gears 30, 32 can be dispensed with in this embodiment. Instead of the lever 40, a toggle lever arrangement is provided having a first lever 52 and a second lever 54 which are connected pivotably to one another in the region of a joint 56. During reverse operation of the electric motor 12 (that is, when the spindle 34 is activated via the free wheel 28), the spindle nut 36 in FIG. 2 moves toward the left-hand side, so that the spring element 38 is prestressed. It can be seen that a movement of this type of the spindle nut 36 in the direction to the left causes (via the toggle lever arrangement of the two levers 52, 54) the second gearwheel 20 which is mounted on the second lever 54 via the rotational axle 48, to move out of engagement with the worm shaft 18.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-13. (canceled)

14. An actuator for a clamping mechanism of an adjustable steering column of a motor vehicle, by way of which actuator a clamping apparatus can be moved between a release position for adjusting the steering column and a clamping position for fixing the steering column in position, the actuator comprising a gear mechanism having a plurality of gear elements (14 to 24) which are in engagement with one another, characterized in that an actuating device (26) is provided, by means of which at least two of the gear elements (18, 20) of the actuator can be moved out of mutual engagement.

15. The actuator as claimed in claim 1, characterized in that the at least two gear elements (18, 20) of the actuator can be moved out of mutual engagement in order to release the clamping position of the clamping apparatus.

16. The actuator as claimed in claim 1, characterized in that a worm shaft (18) and a gearwheel (20) which can be moved out of mutual engagement are assigned to the actuator.

17. The actuator as claimed in claim 3, characterized in that the worm shaft (18) has a pitch, with which the gearwheel (20) which engages into it interacts with a self-locking action when the actuator is at a standstill.

18. The actuator as claimed in claim 1, characterized in that a free wheel (28) is provided, via which the actuating device (26) can be connected to the actuator.

19. The actuator as claimed in claim 1, characterized in that the actuating device (26) comprises a spindle nut (36) which can be moved along a spindle (34) and by means of which one gear element (20) can be moved out of engagement with the other gear element (18).

20. The actuator as claimed in claim 6, characterized in that the spindle nut (36) can be moved counter to the spring force of a spring element (38), via which spring force the two gear elements (18, 20) can be moved back into mutual engagement.

21. The actuator as claimed in claim 5, characterized in that the spindle nut (36) can be moved into an idling state via the free wheel (28), in which idling state the spindle nut (36) can be moved back by means of the spring force of the spring element (38).

22. The actuator as claimed in claim 1, characterized in that one of the two gear elements (20) is mounted on a lever arm which can be displaced by means of the actuating device (26).

23. The actuator as claimed in claim 1, characterized in that a further gear element (10) is provided, by the rotation of which the clamping apparatus can be moved out of the clamping position into the release position.

24. The actuator as claimed in claim 10, characterized in that, after the at least two gear elements (18, 20) have been moved out of mutual engagement, the further gear element (10) can be moved from a position which is assigned to the clamping position of the clamping apparatus into a position which is assigned to the release position of the clamping apparatus by means of a restoring device (50).

25. The actuator as claimed in claim 11, characterized in that the restoring device (50) comprises a spring device which is prestressed with a spring force in its position which is assigned to the clamping position of the clamping apparatus.

26. The actuator as claimed in claim 3, characterized in that the spindle (34) of the actuating device (26) has a considerably greater pitch than the worm shaft (18) of the actuator.

27. The actuator as claimed in claim 7, characterized in that the spindle nut (36) can be moved into an idling state via the free wheel (28), in which idling state the spindle nut (36) can be moved back by means of the spring force of the spring element (38).

28. The actuator as claimed in claim 6, characterized in that the spindle (34) of the actuating device (26) has a considerably greater pitch than the worm shaft (18) of the actuator.
